(19) United States
(12) Patent Application Publication
(10) Pub. No.: US 2009/0074585 A1
(43) Pub. Date: Mar. 19, 2009

(54) WIND TURBINE BLADES WITH TRAILING EDGE SERRATIONS

(75) Inventors: Klaus U. Koegler, Rheine (DE); Stefan Herr, Greenville, SC (US); Murray Fisher, Simpsonville, SC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/857,844

(22) Filed: Sep. 19, 2007

(51) Int. Cl. F03D 11/00; F01D 5/14

(52) U.S. Cl. 416/228; 416/236 R

(57) ABSTRACT

A wind generator and turbine blade includes a trailing edge having several serrations, a length of the serrations in each of a plurality of sections of the trailing edge is between approximately 10% and 40% of a mean chord for the corresponding section; and a length to width ratio of each of the serrations is between approximately 1:1 to 4:1.

### BACKGROUND OF THE INVENTION

1. Technical Field

The subject matter described here generally relates to fluid reaction surfaces with specific blade structures, and, more particularly, to wind turbine blades with trailing edge serrations.

2. Related Art

A wind turbine is a machine for converting the kinetic energy in wind into mechanical energy. If that mechanical energy is used directly by machinery, such as to pump water or to grind wheat, then the wind turbine may be referred to as a windmill. Similarly, if the mechanical energy is further transformed into electrical energy, then the turbine may be referred to as a wind generator or wind power plant.

Wind turbines use one or more airfoils in the form of a “blade” to generate lift and capture momentum from moving air that is them imparted to a rotor. Each blade is typically secured at its “root” end, and then “spans” radially “outboard” to a free, “tip” end. The front, or “leading edge,” of the blade connects the forward-most points of the blade that first contact the air. The rear, or “trailing edge,” of the blade is where airflow that has been separated by the leading edge rejoins after passing over the suction and pressure surfaces of the blade. A “chord line” connects the leading and trailing edges of the blade in the direction of the typical airflow across the blade. The length of the chord line is simply referred to as the “chord.”

Wind turbines are typically categorized according to the vertical or horizontal axis about which the blades rotate. One so-called horizontal-axis wind generator is schematically illustrated in FIG. 1. This particular configuration for a wind turbine 2 includes a tower 4 supporting a drive train 6 with a rotor 8 that is covered by a protective enclosure referred to as a “nacelle.” The blades 10 are arranged at one end of the rotor 8 outside the nacelle for driving a gearbox 12 connected to an electrical generator 14 at the other end of the drive train 6 inside the nacelle.

Although wind energy is one of the fastest growing sources of renewable energy, wind turbine noise is still a major obstacle to implementation. For large, modern wind turbines, aerodynamic noise is considered to be the dominant source of this noise problem, and, in particular, so-called “trailing edge noise” caused by the interaction of turbulence in the boundary layer with the trailing edge of the blade.

Around 1996, under the non-nuclear energy research “Joule III” program, the European Commission began the Serrated Trailing Edge Noise (“STENO”) project aimed at the verification of a prediction algorithm for trailing-edge noise where various serrations were designed and tested in free-field measurements on the with the Universal Wind turbine for Experiments (“UNIWEX”) in Schnittlingen, Germany. Serrations with different total lengths, aspect ratios, and geometries in cross-section profile (straight, bent, curved) were tested. According to the “Publishable Final Report,” bent, 2:1 aspect ratio serrations had almost the same aero-acoustic noise properties as the curved 2:1 aspect ratio serrations, and the larger maximum reduction in the aero-acoustic noise emitted within the moderate frequency range made the longer bent 3:1 serrations preferable to the 2:1 serrations.

As illustrated in FIG. 2, U.S. Pat. No. 7,059,833 to Stiesdal et al. discloses a conventional wind turbine blade having serrations 16 that are triangular in shape, of hexagonal cross-section and having a fairly sharp vertex angle, typically less than 30 degrees. The serrated part of the of the trailing edge is limited to the outboard part of the blade near the tip, having a length of typically 10-20 percent of the span.

FIGS. 3 and 4 from U.S. Pat. No. 7,059,833 to Stiesdal et al., illustrate a serration panel 18 that is disclosed with some preferred dimensions of the serrations suitable for use on wind turbine blades of 20-50 m length. The serration panel 18 can be manufactured from a 1000×110 mm polycarbonate sheet. A serration tooth can be an equilateral triangle with a height of 50 mm. The cross-section can be rectangular, with a thickness of 2 mm, and the panel can be bent along the long axis, as shown in FIG. 4, the bend 20 having an angle of 15 degrees.

FIG. 5 is also copied from U.S. Pat. No. 7,059,833 to Stiesdal et al. and shows a schematic, cross-sectional view of the mounting of the serrated panel 18 on a wind turbine blade. A linear version of the panel may be mounted on the pressure side of the blade, projecting behind the trailing edge. The bent version of the panel 18 shown in FIG. 5, may also be mounted on the pressure side of the blade, projecting behind the trailing edge, or another version may be mounted on the suction side. The panel 18 is manufactured in a material and thickness sufficient to ensure that the angle of the serrated part is generally unchanged irrespective of the speed and angle of the air flow at the trailing edge of the blade. The panel 18 may be manufactured in a material and thickness sufficient to ensure that the angle of the serrated part changes in response to the speed and angle of the air flow at the trailing edge of the blade.

European Patent Application No. 1,338,793 also discloses a wind turbine blade with a serrated trailing edge where the tooth height is defined by the thickness of the boundary layer on the chord surface of the blade. In one embodiment, the tooth height is varied along the length of the blade so that the ratio of the tooth height to the thickness of the boundary layer on the upper and lower chord surface is constant along the length of the blade. This patent also discloses that the thickness of the boundary layer increases in proportion to the to the chord length of the blade according to the equation delta=c L (1/Re)/5, where delta is the thickness of the boundary layer, c is a coefficient having a value of about 0.37, L is the chord length, and Re is the Reynolds number.

In January 2003, the European 5^{th} Framework Project SCIROCO: Silent Rotors by Acoustic Optimization was launched under the coordination of the Energy Research Center of the Netherlands with a goal of addressing this trailing edge noise problem by designing airfoils for which the boundary layer is modified so that trailing edge noise is reduced, while the aerodynamic capabilities are maintained, for varying conditions on a full-scale wind turbine. A second challenge for the project lay in the design and manufacturing of full-scale rotor blades. Since trailing edge noise is mainly generated at the outer part of the blades (where the speeds are highest), any new, low-noise airfoil designs could only be applied at the outer portion of the blade span. In addition to these aerodynamic and acoustic aspects of the problem, aero-elastic, structural, and load issues also had to be carefully considered.

### BRIEF DESCRIPTION OF THE INVENTION

These and other problems associated with such conventional approaches are addressed here by providing, in various configurations, a wind turbine blade, including a trailing edge having a plurality of serrations; a length of the serrations in each of a plurality of sections of the trailing edge being between approximately 10% and 40% of a mean chord for the corresponding section; and a length to width ratio of each of the serrations being between approximately 1:1 to 4:1. Also provided is a wind generator, including a tower supporting a rotor that is connected to a gearbox and a generator; at least one blade, extending radially from the rotor, with a trailing edge having a plurality of triangular serrations arranged substantially coplanar with a trailing edge streamline; a length of the serrations in each of a plurality of sections of the trailing edge being between approximately 18% and 22% of a mean chord for the corresponding section; and a length to width ratio of each of the serrations being between approximately 1.5:1 to 2.5:1.

### BRIEF DESCRIPTION OF THE DRAWINGS

Various aspects of this technology will now be described with reference to the following figures which are not necessarily drawn to scale, but use the same reference numerals to designate corresponding parts throughout each of the several views.

FIG. 1 is a schematic side view of a conventional wind turbine.

FIG. 2 is a schematic, plan view of a portion of a conventional wind turbine blade fitted with a serrated trailing edge.

FIG. 3 is a schematic, plan view of a conventional serrated panel for a wind turbine blade.

FIG. 4 is a side view of the conventional serrated panel for a wind turbine blade shown in FIG. 3.

FIG. 5 is a schematic, cross-sectional view of the mounting of the serrated panel shown in FIGS. 3 and 4 on a wind turbine blade.

FIG. 6 is a partial schematic, plan view of a wind turbine blade.

FIG. 7 is an enlarged, partial plan view of a portion of the serrated panel shown in FIG. 6.

FIG. 8 is a schematic cross-sectional view of the wind turbine blade in FIG. 6.

FIG. 9 is a plot of relative apparent sound pressure level difference versus frequency for two wind turbine blades.

FIG. 10 is a plot of relative apparent sound pressure level difference versus wind speed for two wind turbine blades.

### DETAILED DESCRIPTION OF THE INVENTION

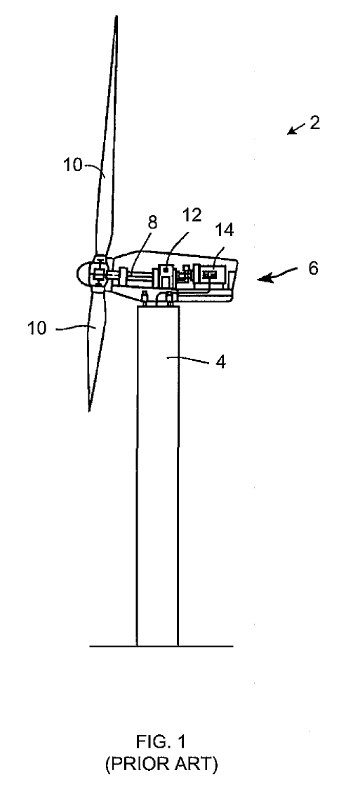

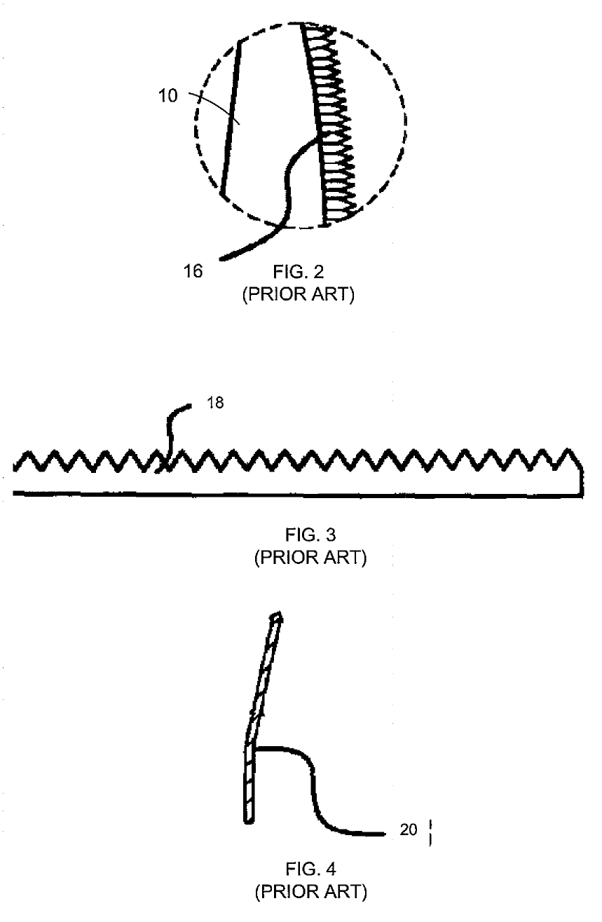

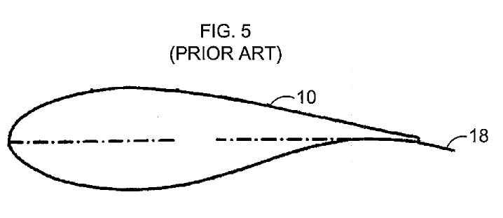

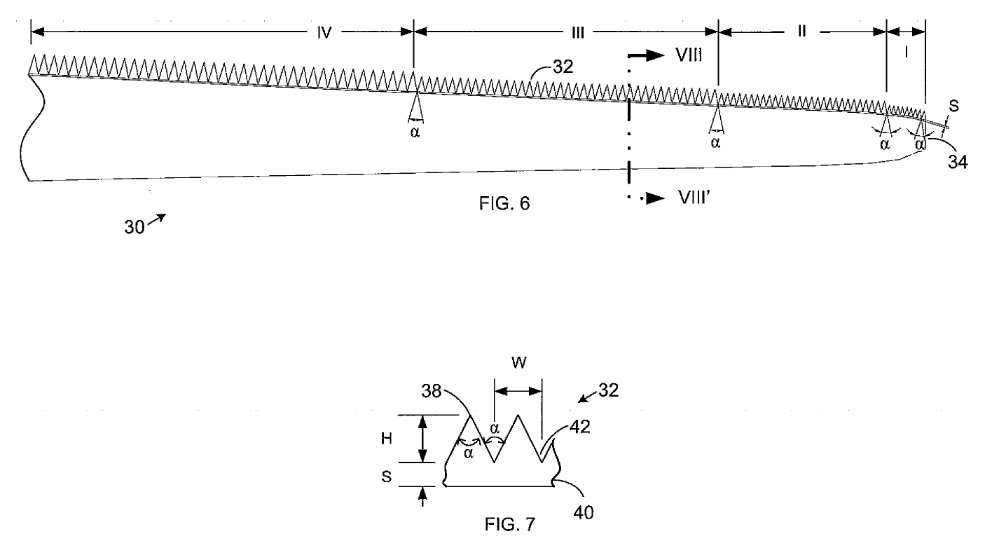

FIG. 6 is a schematic, plan view of one embodiment of a wind turbine blade 30 for use with the wind generator 2 shown in FIG. 1, or any other wind turbine. The blade 30 includes a serrated trailing edge 32 extending inboard from substantially near the tip 34 of the blade. For the examples illustrated here, the serrated trailing edge 32 is divided into four adjacent serrated sections identified by Roman numerals I through IV. However, any other number of sections may be provided, and the various sections may be spaced-apart by portions of the trailing edge without serrations and/or with other serrations.

Each section of the serrated trailing edge 32 may be formed separately or contiguously from any material, including aluminum, plastic, reinforced plastic, fiber reinforced plastic, glass fiber reinforced plastic, and/or other materials. For example, the serrated trailing edge 32 may be formed as one or more relatively stiff plates that do not significantly deform under the expected aerodynamic loads. In this regard, one to two millimeter thick aluminum plate is expected to provide suitable rigidity in many applications. However, less-rigid materials may also be used, and the serrated trailing edge 32 may also be integrally formed with the blade 30.

Each of the illustrated sections I through IV includes a plurality of triangular serrations 38, as best illustrated in enlarged, partial detail in FIG. 7. However, any other shape may also be used for some or all of the serrations 38, including shapes such as semicircular, elliptical, tear-drop, rectangular, and/or square. In the examples illustrated here, each of the serrations 38 extends from a strip 40 having a width “S” for securing to the suction surface of the blade near the trailing edge 32. For example, the strip 40 may be adhesively bonded or otherwise fastened to the suction surface of the blade 30. However, the strip 40 may also be secured to the pressure surface of the blade 30 and/or inserted into the unserrated trailing edge of the blade 30. Although the serrations 38 are illustrated as being contiguous with the strip 40, they may also be separately attached to the strip 40 and/or directly to the blade 30

Each of the triangular serrations 38 illustrated in FIGS. 6 and 7 has an apex ratio of height (or “length”) H to width W of approximately 2:1. This results in an apex angle α for the triangle of approximately 28 degrees. However, other height to width ratios, H:W or H/W, may also be used including a wide range from 1:1 to 4:1 (with corresponding apex angles of 14.25° to 53.13°), and a more narrow range of from 1.5:1 to 2.5:1 (with corresponding apex angles between 22.62° and 36.87°), or approximately 2:1. The height H is typically chosen within a wide range of between 10% and 40%, and a narrower range of 18% and 22%, of the chord length of the blade 30 at the location of the serration 38. Since the chord may vary over the span of each section, an average or mean chord length may be used for each section. Alternatively, or in addition, a median chord length over the section, or a single chord length near the middle of each section may also be used for determining the height (or length) dimension H.

The illustrated troughs 42 between serrations 38 also form an angle α which is the same as the apex angle α at the tip of the serrations. However, the angle α does not necessarily have to be the same for the apex of the triangular serrations 38 and the troughs 42, as, for example, where adjacent serrations do not have the same height to width ratios. Similarly, the troughs 42 are not necessarily V-shaped to correspond with the V-shaped apex of the triangular serrations 38. For example, some or all of the troughs 42 may be U-shaped, semicircular, elliptical, rectangular, and/or square.

The base of troughs 42 may be aligned with the unserrated trailing edge of the of the blade 30 so that only the serrations 38 extend from the unserrated trailing edge of the blade 30. Alternatively, some of the strip 40 may extend past the edge of the unserrated trailing edge of the blade 30. The serrations 38 may also be spaced apart from each other along the strip 40 and/or blade 30.

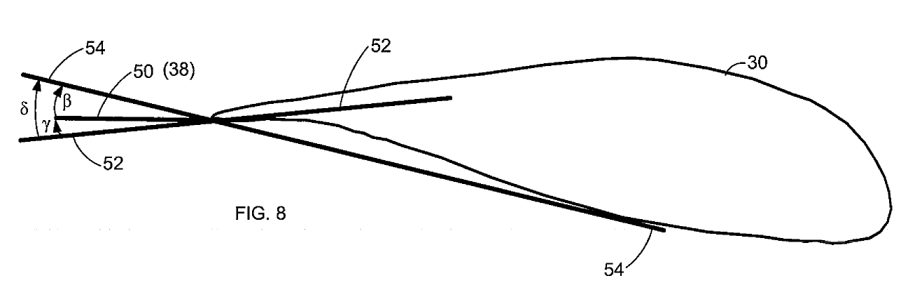

FIG. 8 is a schematic, cross-sectional view of the wind turbine blade taken along chord-wise section line VIII-VIII′ in FIG. 6. FIG. 8 illustrates the serrations 38 arranged on the reference fine 50 which corresponds with the trailing edge streamline of the blade 30. Reference lines 52 and 54 are illustrated on each side of the serrated trailing edge 32. The reference line 52 extends tangential and parallel to the last 5% of the pressure side surface of the blade 32. The reference line 54 extends from the unserrated trailing edge of the pressure side of the blade 32, and is tangent to one other point of the blade contour on the pressure side of the blade 30. Reference line 54 is therefore particularly useful because it is relatively easy to define in the field on an existing blade. The angular position of the serrated trailing edge 32 can then be defined in terms of the angles β or γ relative to reference lines 52 or 54 as shown in FIG. 8. In fact, γ, δ, and β may be mathematically determined from the configuration of the blade 30 relative to the reference line 50, which can be determined from the trailing edge streamlines at the edge 32 of blade 30.

However, the position of the streamlines for a particular blade 30 may change for various wind conditions and blade configurations. Consequently, the linear and angular position of the serrated trailing edge 32 will typically be optimized for each blade 30 and its expected operating environment. Although further optimization can then be obtained by defining a length and position each of the serrations 38 along the lade 30, this would be very difficult for a large blade such as the one illustrated in FIG. 6.

In light of these and other difficulties, the blade 30 can be divided into a suitable number of span-wise sections where each of the serrations 38 may have a similar length and angular configuration in that section. Although any number of sections may be used, a suitable tradeoff has been found using a wide range of between 1 and 10 sections, or a smaller range of between 2 and 6 sections, such as four sections. The four sections labeled with Roman numerals I through IV starling from the tip of the blade 30 that are shown in FIG. 6 are used below to illustrate various embodiments of this technology. However, any other number of sections may also be used.

Each of the serrations 38 may have the same configuration in each section, or the numbers listed below may be averages or medians over the entire section. Furthermore, in the examples below, it is expected that suitable results may be obtained by varying the lengths by a wide range of +/−30% and/or varying the angles by +/−20°, or by varying the lengths by a narrower range of +/−5% and/or varying the angles by +/−5° For example, the values listed below are expected to have engineering tolerances of +/−10% or +/−20°, where applicable.

In one embodiment for use with a Model No. GE46 wind turbine blade available from General Electric Corporation of Fairfield, Conn., USA, four sections may be used with the serrations 38 having a ratio of height H to width W of approximately 2:1 and further configured as follows where lengths are listed in millimeters and angles are listed in degrees:

| | Distance | | | | |
|---|---|---|---|---|---|
| Section | From Blade | | | | |
| Number | Tip | H | δ | β | γ |
| I | 750 | 123 | 6.4 | 7.5 | −1.1 |
| II | 3250 | 171 | 6.4 | 5.5 | 0.9 |
| III | 7400 | 220 | 6.4 | 6.5 | −0.1 |
| IV | 12900 | 284 | 7.7 | 7.0 | 0.7 |

As indicated by the angles for β listed above, each of the serrations is angled between approximately 7.5 and 5.5 degrees from the reference line 54 shown in FIG. 8 that is tangential to the pressure surface of the blade and intersects with the unserrated trailing edge of the blade 30.

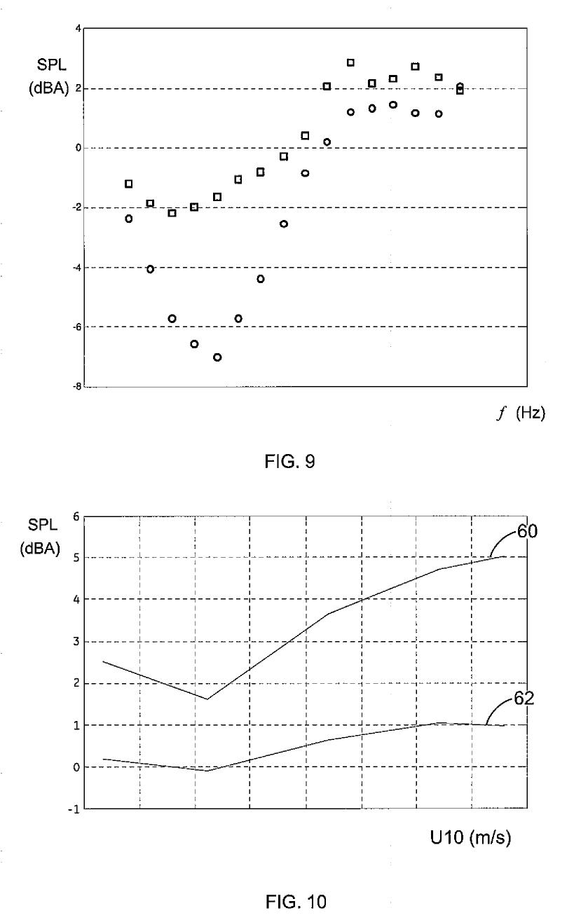

Field measurements that were conducted for a hybrid-rotor 2.3 MW wind generator (with a rotor diameter of approximately 94 meters) including one such blade from GE Energy at the Energy Center of the Netherlands test site in Wieringmeer. The results are illustrated in FIG. 9 where an optimized “SIROCCO” serrated blade specified by the SIROCCO consortium partners is designated with square data points and the serrated GE Energy Model GE46 blade described in the table above is designated with round data points. The vertical axis in FIG. 9 designates relative apparent sound pressure level difference (“SPL”) in decibels as compared to a conventional unserrated Model GE46 blade on the same rotor, while the horizontal axis shows frequency (“f”) in Hertz. FIG. 9 therefore illustrates that the average dopplerized blade noise spectrum for the serrated GE46 blade described above was lower than a similar GE46 blade without serrations. In fact, the overall noise level reduction provide by the serrations was over 6 dBA for at least two frequencies. Furthermore, the serrated GE46 blade performed better than the optimized “SIROCCO” serrated blade at almost all frequencies.

FIG. 10 also illustrates the same relative apparent sound pressure level difference (“SPL”) in decibels as compared to a conventional unserrated Model GE46 blade on the same rotor, where the horizontal axis has been changed to show wind speed at ten meters from the ground (so-called “U10”). In FIG. 10, the upper line 60 represents the serrated Model GE46 blade shown in FIG. 9 with round data points, while the lower line 62 represents the “SIROCCO” blade shown in FIG. 9 with square data points. The upper line 60 in FIG. 10 therefore illustrates that the average dopplerized blade noise spectrum is lower for the GE46 blade with serrations as compared to a similar blade without serrations. Furthermore, the reduction in noise level is greatest at higher wind speeds. In fact, as illustrated by the lower line 62, the serrated GE46 blade performed better than the optimized “SIROCCO” serrated blade at all wind speeds.

In another embodiment for use with a Model No. GE48.7 wind turbine blade available from General Electric Corporation of Fairfield, Conn., USA, four sections may be used with the serrations 38 having a ratio of height H to width W of approximately 2:1 and further configured as follows where lengths are listed in millimeters and angles are listed in degrees.

| | Distance | |
|---|---|---|
| | From Blade | |
| C | Tip | H |
| I | 800 | 150 |
| II | 3500 | 200 |
| III | 7500 | 250 |
| IV | 13000 | 320 |
| V | 20000 | 400 |

In yet another embodiment for use with a Model No. GE40 wind turbine blade available from General Electric Corporation of Fairfield, Conn., USA, four sections may be used with the serrations 38 having a ratio of height H to width W of approximately 2:1 and further configured as follows where lengths are listed in millimeters and angles are listed in degrees listed in millimeters and angles are listed in degrees:

| | Distance | |
|---|---|---|
| | From Blade | |
| C | Tip | H |
| I | 600 | 100 |
| II | 1500 | 150 |
| III | 3000 | 190 |
| IV | 8000 | 230 |
| V | 15000 | 300 |

In the latter two examples, the angles δ may be determined from the blade geometry, and the angles γ and β may be determined from the expected position of the trailing edge streamline for the expected flow conditions.

The technology described above offers a variety of advantages over conventional approaches. For example, the turbine blades can be easily field fitted with the serrated training edge 32 which significantly decreases aerodynamic noise without substantial increases in weight or changes to existing blade molds.

It should be emphasized that the embodiments described above, and particularly any “preferred” embodiments, are merely examples of various implementations that have been set forth here to provide a clear understanding of various aspects of this technology. These embodiments may be modified without substantially departing from scope of protection defined solely by the proper construction of the following claims.

What is claimed is:

1. A wind turbine blade, comprising:
a trailing edge having a plurality of serrations;
a length of the serrations in each of a plurality of sections of the trailing edge being between approximately 10% and 40% of a mean chord for the corresponding section; and
a length to width ratio of each of the serrations being between approximately 1:1 to 4:1.

2. The wind turbine blade recited in claim 1, wherein the length of the serrations is between approximately 18% and 22% of the mean chord for the corresponding section.

3. The wind turbine blade recited in claim 2, wherein the length of the serrations is approximately 20% of the mean chord for the corresponding section.

4. The wind turbine blade recited in claim 1, wherein the length to width ratio of each of the serrations is between approximately 1.5:1 and 2.5:1.

5. The wind turbine blade recited in claim 2, wherein the length to width ratio of each of the serrations is between approximately 1.5:1 and 2.5:1.

6. The wind turbine blade recited in claim 3, wherein the length to width ratio of each of the serrations is approximately 1.5:1 and 2.5:1.

7. The wind turbine blade recited in claim 4, wherein the length to width ratio of each of the serrations is approximately 2:1.

8. The wind turbine blade recited in claim 5, wherein the length to width ratio of each of the serrations is approximately 2:1.

9. The wind turbine blade recited in claim 6, wherein the length to width ratio of each of the serrations is approximately 2:1.

10. The wind turbine blade recited in claim 1, wherein each of the serrations is arranged substantially coplanar with a trailing edge streamline.

11. A wind generator, comprising:
a tower supporting a rotor that is connected to a gearbox and a generator;
at least one blade, extending radially from the rotor, with a trailing edge having a plurality of triangular serrations arranged substantially coplanar with a trailing edge streamline;
a length of the serrations in each of a plurality of sections of the trailing edge being between approximately 18% and 22% of a mean chord for the corresponding section; and
a length to width ratio of each of the serrations being between approximately 1.5:1 to 2.5:1.

12. The wind generator recited in claim 11, wherein a first section of the serrations extends between approximately 600 and 800 millimeters inboard from substantially near a tip of the blade.

13. The wind generator recited in claim 12, wherein a second section of the serrations extends between approximately 1500 and 3250 millimeters inboard from a inboard end of the first section.

14. The wind generator recited in claim 13, wherein a third section of the serrations extends between approximately 3000 and 7500 millimeters inboard from a inboard end of the second section.

15. The wind generator recited in claim 11 wherein
a length of the serrations in a first section is between approximately 100 and 150 millimeters;
a length of the serrations in a second section is between approximately 150 and 200 millimeters; and
a length of the serrations in a third section is between approximately 190 and 250 millimeters.

16. The wind generator recited in claim 14 wherein
a length of the serrations in the first section is between approximately 100 and 150 millimeters:
a length of the serrations in the second section is between approximately 150 and 200 millimeters; and
a length of the serrations in the third section is between approximately 190 and 250 millimeters.

17. The wind generator recited in claim 11 wherein each of the serrations is angled between approximately 5.5 and 7.5 degrees from reference line that is tangential to a pressure surface of the blade and intersects with an unserrated trailing edge of the blade.

18. The wind generator recited in claim 14 wherein each of the serrations is angled approximately 5.5 and 7.5 degrees from the reference line that is tangential to a pressure surface of the blade and intersects with an unserrated trailing edge of the blade.

19. The wind generator recited in claim 15 wherein each of the serrations is angled approximately 5.5 and 7.5 degrees from the reference line that is tangential to a pressure surface of the blade and intersects with an unserrated trailing edge of the blade.

20. The wind generator recited in claim 16 wherein each of the serrations is angled approximately 5.5 and 7.5 degrees from the reference line that is tangential to a pressure surface of the blade and intersects with an unserrated trailing edge of the blade.
